(19) United States
(12) Patent Application Publication
(10) Pub. No.: US 2021/0276156 A1
(43) Pub. Date: Sep. 9, 2021

(54) Yolk Clamp

(71) Applicant: Gerald Lee Moore, Staunton, VA (US)

(72) Inventor: Gerald Lee Moore, Staunton, VA (US)

(21) Appl. No.: 17/195,375

(22) Filed: Mar. 8, 2021

Related U.S. Application Data
(60) Provisional application No. 62/986,704, filed on Mar. 8, 2020.

(51) Int. Cl. B25B 5/06; B25B 5/16

(52) U.S. Cl. CPC B25B 5/068; B25B 5/166

(57) ABSTRACT

Certain exemplary embodiments can provide a system that comprises a bar and a pair of clamps. The bar defines a set of spaced apertures. The pair of clamps comprises a first clamp and a second clamp. Each of the first clamp and the second clamp comprises a first portion and a second portion.

### CROSS-REFERENCES TO RELATED APPLICATIONS

This application claims priority to, and incorporates by reference herein in its entirety, pending U.S. Provisional Patent Application Ser. No. 62/986,704 (Attorney Docket No. 1424-01), filed Mar. 8, 2020.

### BRIEF DESCRIPTION OF THE DRAWINGS

The patent or application file contains at least one drawing executed in color. Copies of this patent or patent application publication with color drawings will be provided by the Office upon request and payment of the necessary fee. A wide variety of potential practical and useful embodiments will be more readily understood through the following detailed description of certain exemplary embodiments, with reference to the accompanying exemplary drawings in which:

FIG. 1 is a photograph of a perspective view of an exemplary embodiment of a system 1000;

FIG. 2 is a photograph of a perspective view of an exemplary embodiment of a system 2000;

FIG. 3 is a photograph of a perspective view of an exemplary embodiment of a system 3000;

FIG. 4 is a set of drawings 4000 of components used in an exemplary embodiment;

FIG. 5 is an exploded view of components 5000 of an exemplary embodiment;

FIG. 6 is a set of drawings 6000 of components used in an exemplary embodiment;

FIG. 7 is a set of drawings 7000 of components used in an exemplary embodiment; and

FIG. 8 is a set of drawings 8000 of components used in an exemplary embodiment.

### DETAILED DESCRIPTION

Certain exemplary embodiments can provide a system that comprises a bar and a pair of clamps. The bar defines a set of spaced apertures. The pair of clamps comprises a first clamp and a second clamp. Each of the first clamp and the second clamp comprises a first portion and a second portion.

Certain exemplary embodiments provide devices, systems, and/or methods for installing building trusses or joists. Such embodiments can be applied, for example, to the installation of wooden roof trusses and/or floor joists in a building. An exemplary system comprises a bar that defines a set of spaced apertures. The set of spaced apertures are constructed to engage with two or more clamps. The claims are positioned at a desired spacing on the bar.

Without some form of temporary support, setting building trusses and/or joists can be difficult when they don't stay in place. Certain exemplary embodiments clamp components of building trusses and/or joists to hold them in place such that they can be fixedly coupled to a structure. Certain exemplary embodiments are constructed to hold roof trusses or floor joists. Clamps simply slide along the bar and can be set in positions compatible with desired spacing of trusses and/or joists. The position of each of the clamps can be adjusted to achieve desired spacings for trusses and/or joists. In certain exemplary embodiments, the clamps can be spaced to up to approximately 25.5 inches.

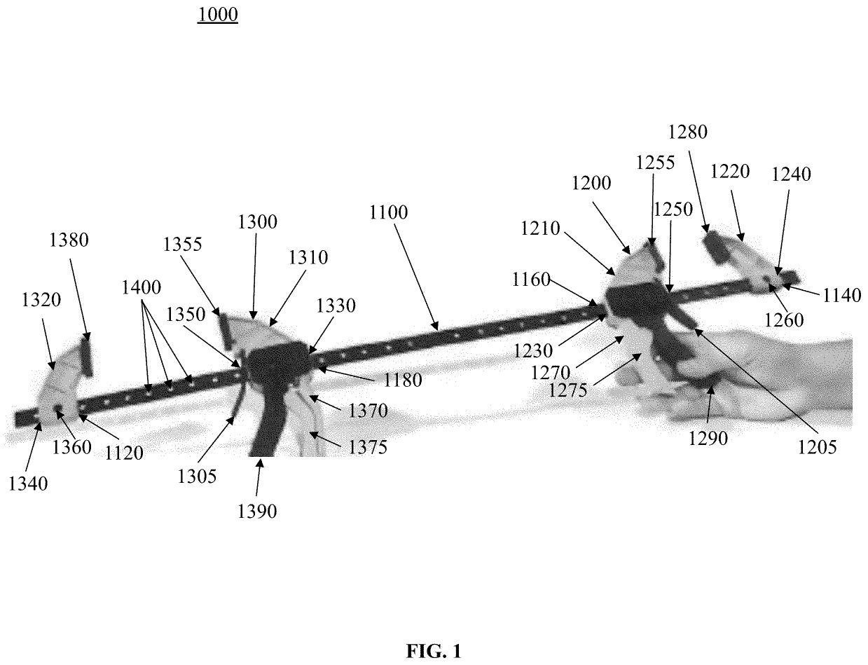

FIG. 1 is a photograph of a perspective view of an exemplary embodiment of a system 1000, which comprises a bar 1100, a first clamp 1200, and a second clamp 1300. Bar 1100 defines a set of spaced apertures 1400. Each aperture of set of spaced apertures 1400 is constructed to engage with first clamp 1200 and/or second clamp 1300 such that a predetermined spacing between first clamp 1200 and second clamp 1300 can be held during a construction of a structure.

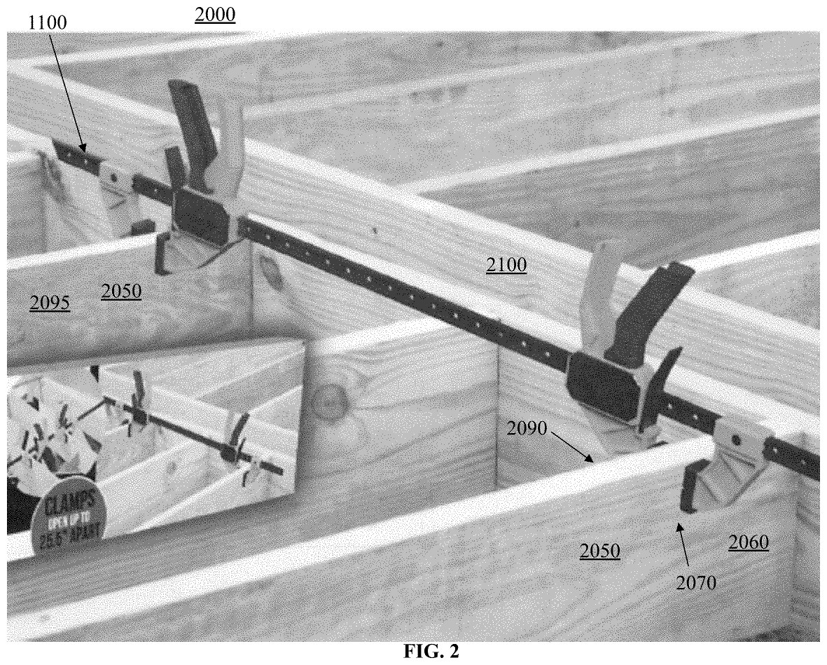

FIG. 2 is a photograph of a perspective view of an exemplary embodiment of a system 2000, which illustrates system 1000 in use in an installation of joists 2050. A first joist 2060 of joists 2050 is fixedly coupled to system 2000. Second joist 2095 can be temporarily coupled to system 2000 via system 1000. The spacing between first joist 2060 and second joist 2095 is held via system 1000 while a user fixedly couples first joist 2060 and second joist 2095 to system 2000.

Bar 1100 defines set of spaced apertures 1400. System 2000 comprises a pair of clamps. The pair of clamps comprising first clamp 1200 and second clamp 1300. Each of first clamp 1200 and second clamp 1300 can comprise:
a first portion (i.e., first portion 1220 of first clamp 1200 and first portion 1320 of second clamp 1300), the first portion of each clamp defining a first tube (i.e., first tube 1240 of first clamp 1200 and first tube 1340 of second clamp 1300), the first tube constructed to substantially surround a first section of the bar (i.e., section 1120 or section 1140 of bar 1100), the first portion of each clamp (i.e., first portion 1220 of first clamp 1200 and first portion 1320 of second clamp 1300) comprising:
   a first lock pin (i.e., first lock pin 1260 of first clamp 1200 and first lock pin 1360 of second clamp 1300) constructed to engage with one of the spaced apertures 1400 of bar 1100 and thereby releasably couple the first portion (i.e., first portion 1220 of first clamp 1200 and first portion 1320 of second clamp 1300) to bar 1100;
   a first pad (i.e., first pad 1280 of first clamp 1200 and first pad 1380 of second clamp 1300) constructed to contact a first side 2070 of first joist 2060 to restrain motion of first joist 2060 of a frame 2100 when system 2000 is fully coupled; and
a second portion (i.e., second portion 1210 of first clamp 1200 and second portion 1310 of second clamp 1300), the second portion of each clamp defining a second tube (i.e., second tube 1230 of first clamp 1200 and second tube 1330 of second clamp 1300), the second tube (i.e., second tube 1230 of first clamp 1200 and second tube 1330 of second clamp 1300) constructed to substantially surround a second section (i.e., section 1160 or section 1180 of bar 1100) of bar 1100, the second portion of each clamp (i.e., second portion 1210 of first clamp 1200 and second portion 1310 of second clamp 1300) comprising:
   a second lock pin (i.e., second lock pin 1250 of first clamp 1200 and second lock pin 1350 of second clamp 1300) constructed to engage with another of the spaced apertures 1400 of bar 1100 and thereby releasably couple the second portion (i.e., second portion 1210 of first clamp 1200 and second portion 1310 of second clamp 1300) to bar 1100;
   a handle (i.e., handle 1270 of first clamp 1200 and handle 1370 of second clamp 1300) comprising:
      a base (i.e., base 1275 of first clamp 1200 and base 1375 of second clamp 1300); and
      a trigger (i.e., trigger 1290 of first clamp 1200 and trigger 1390 of second clamp 1300) movable by a human hand, when moved, the trigger (i.e., trigger 1290 of first clamp 1200 and trigger 1390 of second clamp 1300) is constructed to lock or release the second lock pin (i.e., second lock pin 1250 of first clamp 1200 and second lock pin 1350 of second clamp 1300) from bar 1100;
   a second pad (i.e., second pad 1255 of first clamp 1200 and second pad 1355 of second clamp 1300) constructed to contact a second side 2090 of first joist 2060 to restrain motion of first joist 2060 of frame 2100 when system 2000 is fully coupled, second side 2090 of first joist 2060 opposing first side 2070 of first joist 2060.

In certain exemplary embodiments, system 2000 comprises frame 2100 and first joist 2060, wherein first joist 2060 is coupleable to frame 2100.

In certain exemplary embodiments, one of first clamp 1200 and second clamp 1300 is coupleable to a second joist 2095.

In certain exemplary embodiments, the first pad of each clamp (i.e., first pad 1280 of first clamp 1200 and first pad 1380 of second clamp 1300) comprises an elastomer.

In certain exemplary embodiments, the second pad of each clamp (i.e., second pad 1255 of first clamp 1200 and second pad 1355 of second clamp 1300) comprises an elastomer.

In certain exemplary embodiments, the second portion of each clamp (i.e., second portion 1210 of first clamp 1200 and second portion 1310 of second clamp 1300) comprises a quick release lever (i.e., quick release lever 1205 of first clamp 1200 and quick release lever 1305 of second clamp 1300), the quick release lever constructed to allow the second portion of each clamp (i.e., second portion 1210 of first clamp 1200 and second portion 1310 of second clamp 1300) to be moved relative to bar 1100 when pressed; when quick release lever (i.e., quick release lever 1205 of first clamp 1200 and quick release lever 1305 of second clamp 1300) is held in a first position, the second portion of each clamp (i.e., second portion 1210 of first clamp 1200 and second portion 1310 of second clamp 1300) is slidable along bar 1100; when quick release lever (i.e., quick release lever 1205 of first clamp 1200 and quick release lever 1305 of second clamp 1300) is moved to a second position, the second portion of each clamp (i.e., second portion 1210 of first clamp 1200 and second portion 1310 of second clamp 1300) is locked in position on bar 1100 via second lock pin (i.e., second lock pin 1250 of first clamp 1200 and second lock pin 1350 of second clamp 1300).

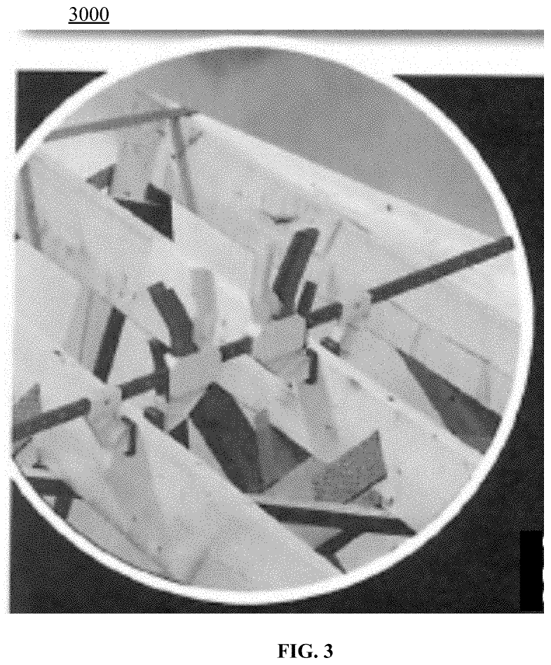

FIG. 3 is a photograph of a perspective view of an exemplary embodiment of a system 3000, which illustrates the use of system 1000 for the installation of roof trusses.

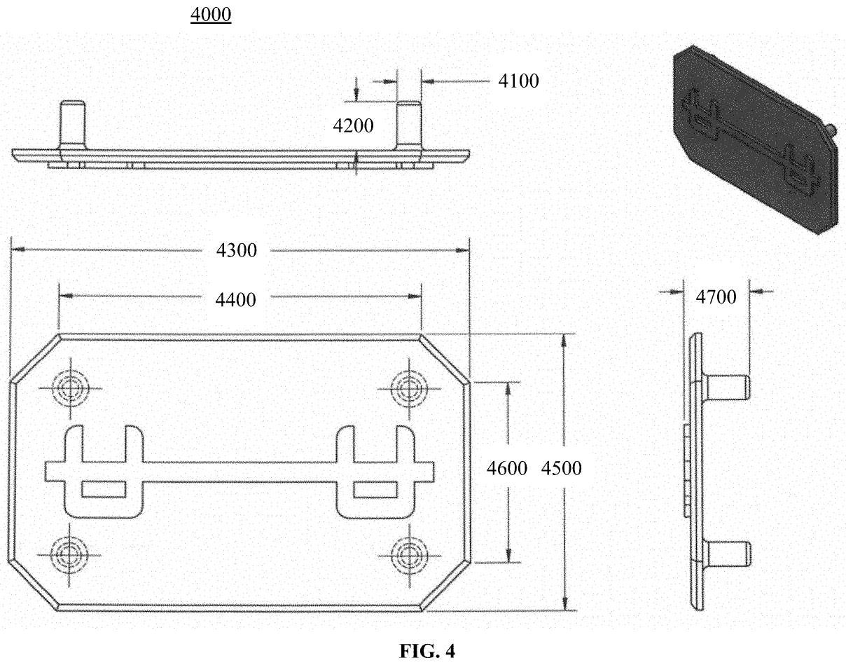

FIG. 4 is a set of drawings 4000 of components used in an exemplary embodiment, which show detailed views of components of system 1000. The dimensions of drawings 4000 as applied to system 1000 can vary based upon application and objects to be releasably coupled. In an exemplary embodiment, the following dimensions can be utilized:

diameter 4100—approximately 3.18 mm;

height 4200—approximately 6.35 mm;

length 4300—approximately 60.33 mm;

spacing 4400—approximately 47.63 mm;

width 4500—approximately 36.32 mm;

spacing 4600—approximately 23.62 mm; and

depth 4700—approximately 8.73 mm.

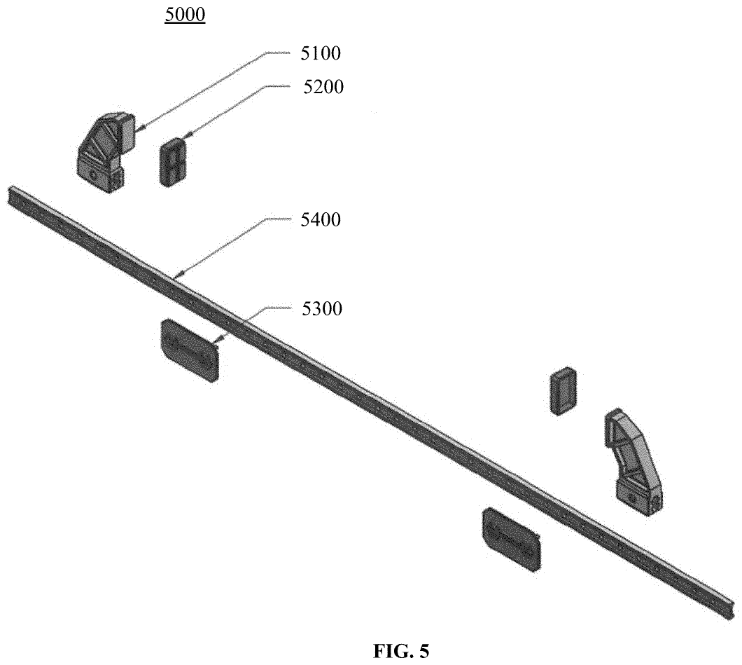

FIG. 5 is an exploded view of components 5000 of an exemplary embodiment. Specifically, components 5000 comprise exploded views of parts of first portion 1220 of first clamp 1200 and/or first portion 1320 of second clamp 1300. Components 5000 comprise a slide mount 5100, a pad 5200, a cover 5300, and a bar 5400.

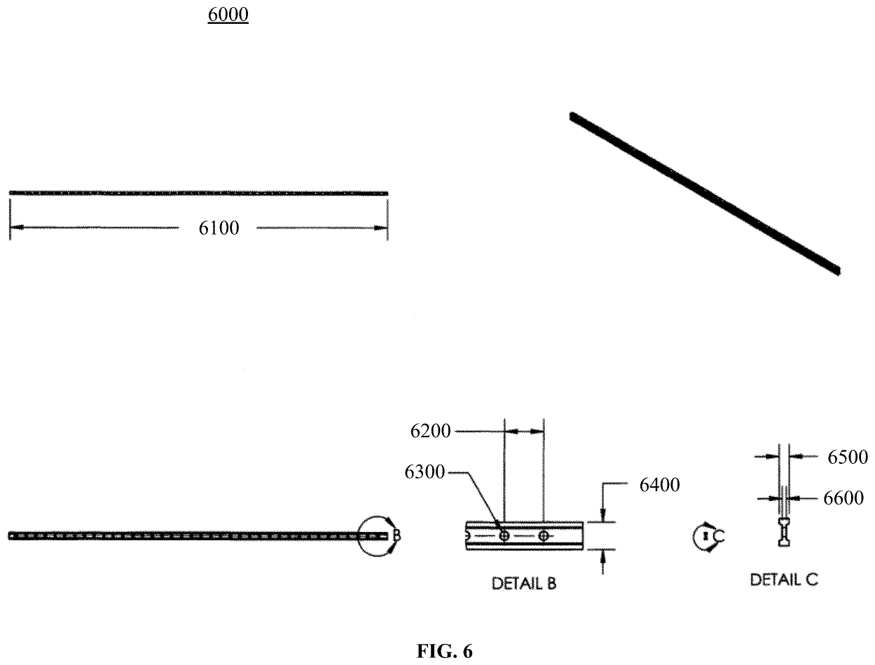

FIG. 6 is a set of drawings 6000 of components used in an exemplary embodiment, which show detailed views of components of system 1000. The dimensions of drawings 6000 as applied to system 1000 can vary based upon application and objects to be releasably coupled. In an exemplary embodiment, the following dimensions can be utilized:

length 6100—approximately 787.40 mm;

spacing 6200—approximately 20.32 mm;

diameter 6300—approximately 4.57 mm;

width 6400—approximately 13.97 mm;

thickness 6500—approximately 5.08; and

thickness 6600—approximately 2.16 mm.

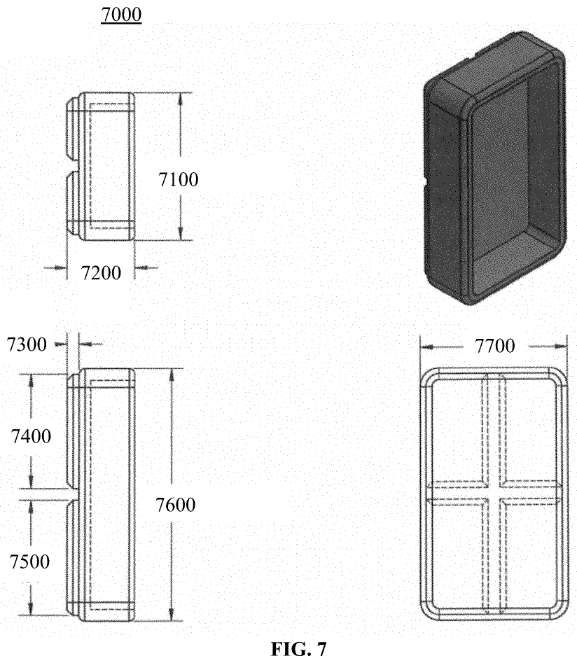

FIG. 7 is a set of drawings 7000 of components used in an exemplary embodiment, which show detailed views of components of system 1000. The dimensions of drawings 7000 as applied to system 1000 can vary based upon application and objects to be releasably coupled. In an exemplary embodiment, the following dimensions can be utilized:

width 7100—approximately 20.07 mm;

thickness 7200—approximately 9.21 mm;

thickness 7300—approximately 1.59 mm;

spacing 7400—approximately 15.59 mm;

spacing 7500—approximately 15.59; and

length 7600—approximately 34.29 mm; and

width 7700—approximately 20.07 mm.

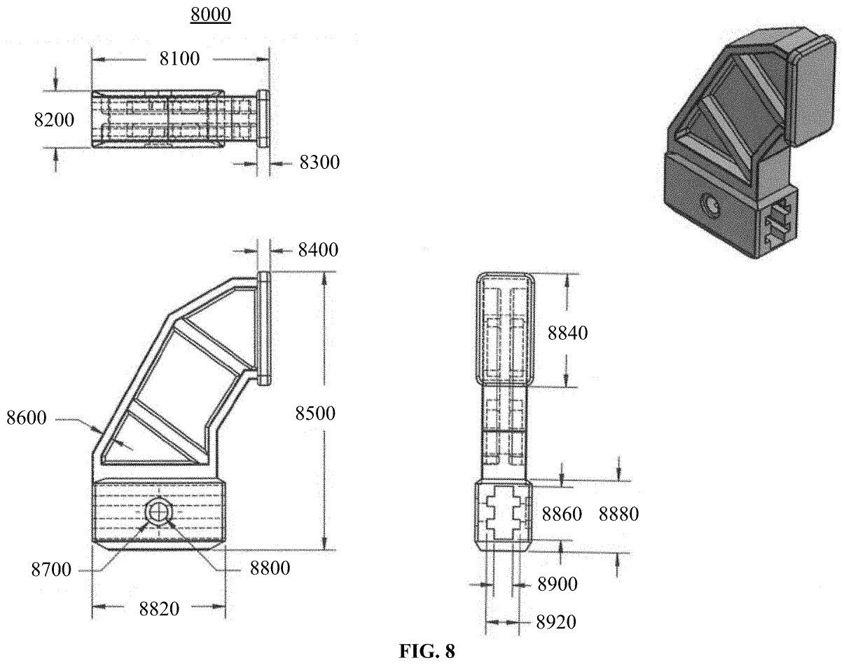

FIG. 8 is a set of drawings 8000 of components used in an exemplary embodiment, which show detailed views of components of system 1000. The dimensions of drawings 8000 as applied to system 1000 can vary based upon application and objects to be releasably coupled. In an exemplary embodiment, the following dimensions can be utilized:

length 8100—approximately 47.38 mm;

width 8200—approximately 15.01 mm;

thickness 8300—approximately 3.43 mm;

thickness 8400—approximately 3.43 mm;

height 8500—approximately 73.98 mm;

thickness 8600—approximately 2.54;

diameter 8700—approximately 7.24 mm;

diameter 8800—approximately 4.83 mm;

width 8820—approximately 35.31 mm;

height 8840—approximately 30.30 mm;

height 8860—approximately 13.97 mm;

height 8880—approximately 18.94 mm;

width 8900—approximately 5.08 mm; and

width 8920—approximately 8.89 mm.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.

a—at least one.

activity—an action, act, step, and/or process or portion thereof.

adapter—a device used to effect operative compatibility between different parts of one or more pieces of an apparatus or system.

and/or—either in conjunction with or in alternative to.

apparatus—an appliance or device for a particular purpose.

aperture—an opening in something.

associate—to join, connect together, and/or relate.

bar—a length of material.

base—a supporting portion of something.

can—is capable of, in at least some embodiments.

clamp—n. a device used to join, grip, support, and/or compress. v. to join, grip, support, and/or compress.

comprising—including but not limited to.

configure—to make suitable or fit for a specific use or situation.

connect—to join or fasten together.

constructed to—made to and/or designed to.

couple—to link in some fashion.

coupleable—capable of being joined, connected, and/or linked together.

define—to establish the outline, form, or structure of

device—a machine, manufacture, and/or collection thereof.

elastomer—a polymer with viscoelasticity (having both viscosity and elasticity) and very weak inter-molecular forces, generally having low Young's modulus and high failure strain compared with other materials.

engage—to be in contact and interact with.

fastener—one (or more) restraints that attach to, extend through, penetrate, and/or hold something. For example, a fastener can be one (or more) bolt and nut assembly, rivet, weldment, nail, screw, peg, staple, clip, buckle, clasp, clamp, hook and loop assembly, adhesive, and/or plastic push rivet, etc.

fixedly—coupled so as to be firm and substantially not nondestructibly removable.

frame—a supporting structure.

fully—substantially completely.

handle—a part of a thing sized and/or shaped specifically to be grasped or held by a hand of a user.

install—to connect or set in position and prepare for use.

joist—a structural member used in framing to span an open space, often between beams that subsequently transfer loads to vertical members. When incorporated into a floor framing system, joists serve to provide stiffness to the subfloor sheathing, allowing it to function as a horizontal diaphragm.

lever—a device comprising a rod or strip of material pivoted at a fixed hinge.

lock—(n) a fastener; (v) to fasten.

may—is allowed and/or permitted to, in at least some embodiments.

method—a process, procedure, and/or collection of related activities for accomplishing something.

motion—a process via which something changes position from one location to another.

opposing—to be positioned so as to be on an opposite side of something.

pair—two similar things used together.

pin—a slender piece of solid material.

plurality—the state of being plural and/or more than one.

portion—a part of a whole.

position—a location.

predetermined—established in advance.

provide—to furnish, supply, give, and/or make available.

quick—relatively fast.

receive—to get, take, acquire, and/or obtain.

release—to free from something that fastens or holds.

releasable—coupled so as to be substantially nondestructibly removable.

repeatedly—again and again; repetitively.

restrain—to limit motion of something.

set—a related plurality.

side—a bounding surface of an object.

spaced—set apart by a predetermined distance.

store—to place, hold, and/or retain.

substantially—to a great extent or degree.

support—to bear the weight of, especially from below.

surround—to enclose on at least four sides.

system—a collection of mechanisms, devices, machines, articles of manufacture, processes, data, and/or instructions, the collection designed to perform one or more specific functions.

trigger—a device that releases a catch

tube—an elongated channel that is shaped to conform to a shape of a bar.

via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a bar, the bar defining a set of spaced apertures;
a pair of clamps, the pair of clamps comprising a first clamp and a second clamp, each of the first clamp and the second clamp comprising:
a first portion, the first portion of each clamp defining a first tube, the first tube constructed to substantially surround a first section of the bar, the first portion of each clamp comprising:
a first lock pin constructed to engage with one of the spaced apertures of the bar and thereby releasably couple the first portion to the bar;
a first pad constructed to contact a first side of a first joist to restrain motion of the first joist of a frame when the system is fully coupled; and
a second portion, the second portion of each clamp defining a second tube, the second tube constructed to substantially surround a second section of the bar, the second portion of each clamp comprising:
a second lock pin constructed to engage with another of the spaced apertures of the bar and thereby releasably couple the second portion to the bar;
a handle, the handle comprising:
a base; and
a trigger, the trigger movable by a human hand,
when moved, the trigger is constructed to lock or release the second lock pin from the bar;
a second pad, the second pad constructed to contact a second side of the first joist to restrain motion of the first joist of the frame when the system is fully coupled, the second side of the first joist opposing the first side of the first joist.

2. The system of claim 1, further comprising:
the frame; and
the first joist, wherein the first joist is coupleable to the frame.

3. The system of claim 1, wherein:
one of the first clamp and the second clamp is coupleable to a second joist.

4. The system of claim 1, wherein:
the first pad of each clamp comprises an elastomer.

5. The system of claim 1, wherein:
the second pad of each clamp comprises an elastomer.

6. The system of claim 1, wherein:
the second portion of each clamp comprises a quick release lever, the quick release lever constructed to allow the second portion of each clamp to be moved relative to the bar when pressed; when quick release lever is held in a first position, the second portion of each clamp is slidable along the bar; when quick release lever is moved to a second position, the second portion of each clamp is locked in position on the bar via the second lock pin.
